(19) United States
(12) Patent Application Publication
(10) Pub. No.: US 2020/0070298 A1
(43) Pub. Date: Mar. 5, 2020

(54) Variable Offset Tungsten Electrode Sharpening and Grinding Attachment for GTAW Welding Processes

(71) Applicant: Joel Walker Bradley, Lexington, KY (US)

(72) Inventor: Joel Walker Bradley, Lexington, KY (US)

(21) Appl. No.: 16/550,187

(22) Filed: Aug. 24, 2019

Related U.S. Application Data
(60) Provisional application No. 62/723,996, filed on Aug. 28, 2018.

(51) Int. Cl. B24B 19/16; B23K 9/26

(52) U.S. Cl. CPC B24B 19/16; B23K 9/26

(57) ABSTRACT

An electrode sharpener has a main housing, which has a threaded bore to attach to the end of a rotary tool. The housing has guides threaded into it, which position tungsten electrodes for grinding against an abrasive wheel that is inserted into the rotary tool's collet.

### CROSS-REFERENCE TO RELATED APPLICATIONS

Not applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not applicable

### BACKGROUND OF THE INVENTION

During GTAW welding processes, it is necessary that the electrode being used be sharpened periodically to maintain the quality of the welding process. There are several current methods to sharpen these electrodes, but handheld-type devices will be discussed herein. Handheld electrode sharpeners use a rotary tool with an abrasive wheel paired with a device to hold the electrode at a predetermined orientation to the abrasive wheel to complete this process. When the electrode dulls, the operator can take the electrode, insert it into the sharpening guide, turn the rotary tool on, and manually rotate the electrode within the guide to sharpen it to a point.

Currently, these handheld devices exist in 2 forms—a standalone tool where the rotary tool and guide assembly are purchased as one unit, and as an attachment to a user-provided rotary tool where only the guide assembly is provided to the user. Both of the existing devices share the same flaw—Once the abrasive material on the tool wears, the tool will not sharpen an electrode as desired. With a standalone sharpener, the user must adjust the location of the electrode guide (requiring common hand tools) to place the electrode at a location on the abrasive wheel with new abrasive. This process requires approximately 3 minutes to complete. With current attachment-type sharpeners, once the abrasive is worn, the user must replace the abrasive wheel with a new one—no adjustment is possible.

### BRIEF SUMMARY OF THE INVENTION

The invention to be discussed herein is an attachment-type electrode sharpener that threads onto a user-provided rotary tool utilizing multiple electrode guides to eliminate adjustment required on current devices.

### BRIEF DESCRIPTION OF THE SEVERAL VIEWS OF THE DRAWING

FIG. 1: Assembled view

Depicts the tungsten grinding attachment assembled with the user supplied rotary tool, abrasive wheel, and electrodes in place for grinding.

FIG. 2: Top View

Shows the array of guides with electrodes in place to describe the variable offsets from centerline.

FIG. 3: Side View

Describes the angle at which the guides position the electrodes to the abrasive wheel.

FIG. 4: Disassembled View

Depicts the attachment alone, which is machined from a solid bar of stock

FIG. 5: Offset Depiction

Depicts how electrodes are offset from centerline to allow full radial usage of the abrasive wheel.

### DETAILED DESCRIPTION OF THE INVENTION

### Construction:

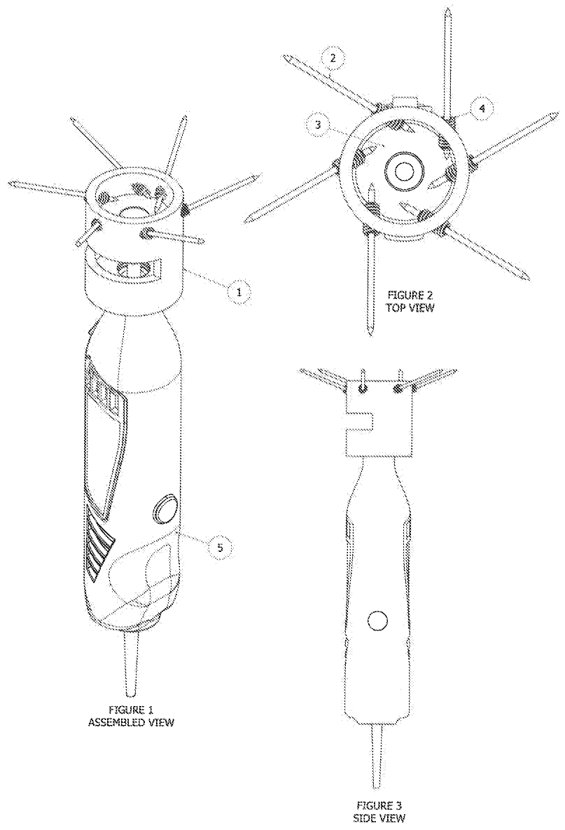

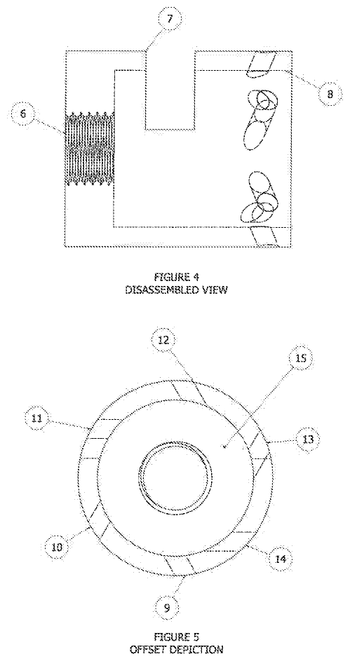

The device being invented is machined from acetal copolymer, aluminum, or any material of equivalent physical properties. Referring to FIGS. 1 through 4, the attachment 1 is a solid piece of material, with a bore 8 allowing clearance for an abrasive wheel 3 and a threaded hole 6 for attachment to common rotary tools 5. Referring now to FIG. 5, guide holes 9-14 are then drilled and tapped into the body of the attachment at different angles relative to the face of the abrasive wheel and different offsets from the centerline axis of the rotary tool. The tapped hole 9

### Method of Operation:

The user will thread the sharpening attachment 1 onto their rotary tool 5, then install the abrasive wheel 3 into the rotary tool's collet and tighten it through the access slot 7. Once their electrode 2 dulls from the welding process, the operator will power on the rotary tool 5, insert the electrode 2 into the guide 4 of their choice, and rotate the electrode 2 as it is ground on the abrasive wheel 3. Should the abrasive become worn, the operator can insert the electrode into a different guide pre-positioned at a different radial location of the abrasive wheel, requiring no tools and no adjustment.

1) Multiple fixed guides arrayed about the axis of rotation, each one having a unique and defined offset from the axis of rotation of the rotary tool. That is, guide 9 is positioned at the innermost radial location, guide 10 is offset towards the outside of the bore 15 further than guide 9. Guide 11 is offset from guide 10 towards the outside, and so on, with guide 14 being positioned at the furthest location towards the outside of the bore 15.
